(19) United States
(12) Patent Application Publication
(10) Pub. No.: US 2012/0266776 A1
(43) Pub. Date: Oct. 25, 2012

(54) Aerial Tramway Carrier Conveyance By Linear Synchronous Motor

(75) Inventors: Charles R. Peterson, Glenwood Springs, CO (US); Jeffrey A. Peterson, New Castle, CO (US)

(73) Assignee: Tramway magnetic Conveyance, LLC

(21) Appl. No.: 13/456,191

(22) Filed: Apr. 25, 2012

Related U.S. Application Data
(60) Provisional application No. 61/478,838, filed on Apr. 25, 2011.

(51) Int. Cl. B61B 7/04; H02K 41/03; B61B 12/00; B60L 13/03

(52) U.S. Cl. 105/149.2; 104/290; 105/150

(57) ABSTRACT

An aerial tramway system that conveys carriers between terminals along a haul rope, in which the carriers (a) detach from the haul rope within at least one of the terminals for loading and unloading, and (b) reattach to the haul rope for conveyance to the next terminal, includes one or more Linear Synchronous Motors (LSMs) within at least one of the terminals, that move the carriers for at least part of the time that the carriers are detached from the haul rope. The system also includes a plurality of the carriers, each carrier comprising a reaction rail that includes at least one magnet configured for magnetic interaction with the one or more LSMs. A carrier for an aerial tramway system includes a chair, a freight carrier or a gondola, and a reaction rail that interacts with a linear synchronous motor of the system, to control movement of the carrier.

### CROSS-REFERENCE TO RELATED APPLICATIONS

This application claims priority to U.S. Provisional Patent Application No. 61/478,838, filed 25 Apr. 2011 and incorporated herein by reference in its entirety.

### BACKGROUND

Detachable aerial tramway systems are used to transport people and/or cargo. These systems are commonly known as chairlifts or gondolas, and are often used at resorts to transport skiers and other recreational users. Most aerial tramways use a single haul rope spliced together to create an endless loop driven at one end by a drive bullwheel rotating in a horizontal plane; a horizontal idler bullwheel supports the opposite end of the haul rope loop. Intermediate sheaves of rollers, positioned on towers, support the haul rope and carriers as they move around the loop. Carriers are uniformly spaced along the length of the haul rope to spread the load over the length of the cable and therefore control tower sheave loading. Terminals of tramway systems are typically designed for loading and unloading passengers and/or cargo to and from the carriers as they arrive and depart the terminals. (In the present application, any facility for loading and/or unloading carriers of such systems is called a “terminal” as is common in the art, although it is understood that some such terminals are not always at end points of such systems. For example, a terminal may be located at an intermediate point of a tramway system for loading and/or unloading people or cargo.)

Some aerial tramways utilize carriers (typically chairs) that are permanently or semi-permanently installed on the haul rope, but detachable aerial tramways utilize carriers that have a detachable grip that couples the carrier to a continuously moving haul rope. The grip's coupling force is maintained on the haul rope by a variety of methods that typically utilize stored energy. Energy is stored in compressed coil springs, stacked belleville spring washers or other devices. The gripping force is applied to a mobile grip jaw that forces the haul rope against an opposing fixed grip jaw. This gripping force maintains the carrier's position on the haul rope as it moves between terminals.

As a carrier enters a terminal, the carrier's weight transfers to a terminal support rail. A terminal guide rail captures the incoming swinging grip guide roller to control lateral swing of the grip body. Lateral swing, perpendicular to the haul rope, is dampened by alignment tires. The detachable grip is mechanically forced open by an opening rail exerting a force on a grip opening roller mounted on the grip. Once the grip opens, the position of either the haul rope or the support rail raises the grip above the rope. From that point until it reattaches to the haul rope, the carrier movement is under the mechanical control of the aerial tramway terminal carrier conveyance system.

Once the grip is detached from the haul rope, the conveyance system decelerates the carrier to a slower, but usually constant speed, for passenger/cargo unloading and loading. Following the unloading and loading, the conveyance system accelerates the carrier to the same speed as the haul rope, in an acceleration ramp. At the end of the acceleration ramp, the profile of the opening rail forces the grip opening roller down and opens the mobile grip jaw. Once the carrier and haul rope are traveling at the same speed, the profile of the opening rail releases the grip opening roller and allows stored energy in the grip body to close the mobile grip jaw and attach to the haul rope. Minimizing relative speed between the carrier and the haul rope is essential to eliminate grip slippage, which can damage the outer wires of the haul rope.

When not attached to the haul rope, the weight of the carriers is supported by and runs along the path of the terminal support rail. The grip guide roller is contained in the terminal guide rail. The carrier movement along the terminal support rail is controlled by a continuous series of rotating tires that are interconnected by V-belts or gears. The drive ratio between adjacent tires or gears controls the rotational speed of the tires and therefore the speed of the carriers in the terminal.

Power to drive the tire system is generated from a power-take-off device tied to the haul rope. The speed of each tire in the system is proportional to the haul rope speed. These known ratios allow the carriers to move through the terminal at a speed proportional to the haul rope speed and thus maintain the carrier spacing until the carrier is reattached to the haul rope.

The tires are in constant contact with a grip friction plate attached above the grip body. Because there is minimal slippage between the surface of the tire and the grip friction plate, the carrier speed is controlled by the rotational speed of the individual tire pushing or pulling the grip friction plate forward. The length of the grip friction plate is longer than the center spacing of the tires; thus the friction plate is always in contact with at least one rotating tire. The original pulley ratio design determines the carrier movement through the terminal. Once the ratios are set, it is not possible to modify carrier movement without major mechanical modifications.

The haul rope speed and the carrier deceleration rate control the total length of the deceleration ramp. The design assumes that there is no slippage between the incoming carrier friction plate and the rotating tires. Slippage in grip deceleration is common in winter environments when ice can collect on the friction plate and reduce the friction factor between the ice covered friction plate and the rotating tires. The variation between design conditions and real world conditions necessitates the inclusion of a carrier spacing system. Once the carrier is decelerated to the unloading/loading speed the spacing system can stall or accelerate the carrier in order to move the carrier back toward the correct spacing.

Detachable aerial tramway systems have been in operation in the United States since 1982 and have an outstanding safety record. The grips have proven durable over a long lifespan and there have been very few accidents involving these systems. Programmable Logic Controllers (PLCs) provide more complex controls and monitoring capabilities and have increased the safety of the tramway systems even further.

Though current mechanical designs of aerial tramway terminal conveyance systems have proven reliable, they can be complex and costly to design, manufacture, construct, maintain and operate. Some limitations of such systems include:
Carrier movements within the terminal are typically controlled by established ratios between the haul rope speed and the rotating speed of the tires in direct contact with the grip friction plates. The carriers move in “lockstep” with the cable to maintain spacing of carriers on the cable (at a coarse level), precluding significant independent control of each individual carrier within the terminal.
Slippage between the grip friction plates and the rotating tires can be caused by various factors, including ice buildup on the grip friction plate, low air pressure in the pneumatic tires and loose V-Belts. Any of these can result in changes to the carrier spacing. An independent carrier spacing system located in the slow speed section is often installed to adjust incorrect carrier spacing at a fine level. Due to the system's limited length, its ability to adjust spacing gaps may be minimal
Carriers typically cannot be removed from the system at the terminals without creating a gap in the outgoing stream of carriers. A PLC may keep a gap open or may allow the spacing system to slowly re-space the carriers evenly across the system.
Carriers typically cannot be easily added to the tramway once the line is fully populated, because there are no gaps in the incoming stream of carriers. Adding a carrier to a fully populated line usually requires that a gap be slowly created by adjusting carrier spacing over a series of line revolutions.
Each carrier's movement in the terminal is typically in direct relationship with all of the other carriers in the terminal and with speed of the haul rope. Such a “lockstep” mechanical relationship among the carriers requires the shutdown of the entire tramway system if an unexpected operational condition occurs in one carrier. Any shutdown decreases the hourly capacity of the tramway.
The “lockstep” nature of the carrier movements to the haul rope speed precludes adjustment of the carrier attachment and detachment processes, limiting flexibility to adjust carrier speed, acceleration and/or deceleration in response to operating conditions (such as presence of small children or novices as chairlift riders).
Long term maintenance costs can be high. Maintenance personnel must typically be properly trained and experienced for the system to perform consistently.
Mechanical conveyance systems within the terminals can be a major cost over the lifetime of the tramway, because they involve a large number of moving parts that are expensive to construct, install and maintain. Depending on a terminal's design, there may be, for example, around 70 rotating tires, pulleys and V-Belts in the terminal to decelerate, convey and accelerate the carriers.
Tires and pulleys of present systems may limit travel paths of carriers within terminals. Mechanical relationships among the tires can restrict the practical limits of a tire banks length due to rotational torque energy requirements. Longer travel distances within a terminal (e.g., when moving carriers to storage facilities) may require an independent power source. Multiple travel paths can be limited by the mechanical nature of the conveyance system. Tires and pulleys may interfere with otherwise desirable switching paths.
To maintain a grip, carriers must be removed from existing systems for disassembly and inspection. With mechanical conveyance systems, this process requires that the tramway stop, switch rails have to be moved and often carriers are manually pushed off of the tramway. Once off line, a gap typically remains open while the carriers are maintained. The process is reversed as carriers are placed back on line, which is equally cumbersome.
The forces required to operate the mechanical conveyances are significant, and the power trains that transmit these forces can present dangerous locations, such as pinch points where an article of clothing or a human appendage can easily be pulled into the apparatus.

### SUMMARY

In an embodiment, an aerial tramway system conveys carriers between terminals along a haul rope. The carriers (a) detach from the haul rope within at least one of the terminals for loading and unloading, and (b) reattach to the haul rope for conveyance to the next terminal. The system includes one or more Linear Synchronous Motors (LSMs) within at least one of the terminals, that move the carriers for at least part of the time that the carriers are detached from the haul rope. The system also includes a plurality of the carriers, each carrier including a reaction rail having at least one magnet configured for magnetic interaction with the one or more LSMs.

In an embodiment, an improvement is set forth in an aerial tramway system that conveys carriers between terminals along a haul rope, in which the carriers (a) detach from the haul rope at one or more detachment points within at least one of the terminals for loading and unloading, and (b) reattach to the haul rope at one or more reattachment points for conveyance to the next terminal. The improvement includes one or more Linear Synchronous Motors (LSMs) within at least one of the terminals. The LSMs move the carriers for at least part of the time that the carriers are detached from the haul rope. The improvement also includes a plurality of reaction rails, each of the reaction rails is associated with one of the carriers and configured for electromagnetic interaction with the one or more LSMs, to move the carriers.

In an embodiment, a carrier for an aerial tramway system includes a chair, a freight carrier or a gondola, and a reaction rail configured for magnetic interaction with a linear synchronous motor of the tramway system, to control movement of the carrier.

In an embodiment, a retrofit kit for a carrier of an aerial tramway system includes a reaction rail configured for attachment with the carrier. The reaction rail includes one of a permanent magnet and an electromagnet, for magnetic interaction with a linear synchronous motor of the tramway system, to control movement of the carrier for at least part of the time that the carrier is detached from a haul rope of the tramway system.

In an embodiment, a method of moving a carrier of an aerial tramway system includes clamping the carrier to a haul rope to move the carrier between terminals of the aerial tramway system, releasing the carrier from the haul rope at one of the terminals, and utilizing one or more Linear Synchronous Motors (LSMs) to move the carrier within the one of the terminals.

### BRIEF DESCRIPTION OF THE DRAWINGS

Exemplary embodiments are illustrated in referenced figures of the drawings. It is intended that the embodiments and figures disclosed herein are to be illustrative rather than limiting.

FIG. 1 schematically shows an aerial tramway system that utilizes LSMs to move carriers within terminals thereof, in accord with an embodiment.

FIG. 2A is a schematic plan view of a portion of an aerial tramway system, in accord with an embodiment.

FIG. 2B is a schematic side elevation of the portion of the aerial tramway system of FIG. 2A.

FIG. 3A is a cross-sectional front elevation of one grip that releasably attaches a carrier to a haul rope, in accord with an embodiment.

FIG. 3B is a top plan view of the grip of FIG. 3A.

FIG. 3C is a side elevation of the grip of FIG. 3A.

FIG. 4A is a side elevational detail showing carrier entry into a terminal of the aerial tramway system of FIG. 2A, in accord with an embodiment.

FIG. 4B is a side elevational detail showing carrier exit from a terminal of the aerial tramway system of FIG. 2A, in accord with an embodiment.

FIG. 5A is a schematic cross-section of a carrier grip interacting with alignment tires and a grip opening rail, in accord with an embodiment.

FIG. 5B is a schematic cross-section of a reaction rail of a carrier grip interacting with a linear synchronous motor stator, in accord with an embodiment.

FIG. 6A is a front elevation cross-sectional schematic view of a carrier grip configured with both a reaction rail and a friction plate, with the friction plate interacting with alignment tires, in accord with an embodiment.

FIG. 6B is a front elevation cross-sectional schematic view of the carrier grip of FIG. 6A, with the reaction rail of the carrier grip interacting with a linear synchronous motor stator, in accord with an embodiment.

FIG. 6B is a front elevation cross-sectional schematic view of a carrier grip configured with both a reaction rail and a friction plate, with the reaction rail interacting with a linear synchronous motor stator to the side of the path of the grip through a terminal, in accord with an embodiment.

FIG. 7 schematically illustrates alternate carrier paths for an aerial tramway system utilizing LSMs, in accord with an embodiment.

FIG. 8 schematically illustrates an alternate carrier path to a carrier storage facility in an aerial tramway system utilizing LSMs, in accord with an embodiment.

FIG. 9 is a schematic block diagram of an aerial tramway system, illustrating control of the system by a master PLC and a monitoring PLC, in accord with an embodiment.

FIG. 10 is a flowchart of a method 200 of moving a carrier on an aerial tramway system utilizing LSMs, in accord with an embodiment.

### DETAILED DESCRIPTION OF THE DRAWINGS

The following description is presented to enable one of ordinary skill in the art to make and use the embodiments herein, and is provided in the context of a patent application and its requirements. Various modifications to the described embodiments will be readily apparent to those skilled in the art, and the principles herein may be applied to other embodiments. Thus, the present disclosure is not intended to be limited to the embodiments shown but is to be accorded the widest scope consistent with the principles and features described herein. The following embodiments and aspects thereof are described and illustrated in conjunction with systems, tools and methods that are meant to be exemplary and illustrative, not limiting in scope. In various embodiments, one or more limitations of the prior art have been addressed, while other embodiments are directed to other improvements.

This disclosure includes the following detailed description taken in conjunction with the drawings as described below. It is noted that, for purposes of illustrative clarity, certain elements in the drawings may not be drawn to scale. Variants of similar elements may be denoted by addition of prime (′) or double prime (″) marks to reference numerals.

Table of elements described herein:

| | |
|---|---|
| 1, 1′ | Aerial Tramway System |
| 10 | Haul Rope |
| 12, 12′ | Carrier (grip, hanger and chair, gondola cabin or platform) |
| 14 | Carrier Hanger |
| 16 | Bullwheel |
| 18, 18′, 18″ | Tramway Terminal |
| 20 | Grip |
| 22 | Grip Stored Energy |
| 24 | Grip Mobile Jaw |
| 26 | Grip Fixed Jaw |
| 28 | Grip Support Roller |
| 29 | Friction Plate |
| 30 | Grip Opening Roller |
| 32 | Grip Guide Roller |
| 34 | Reaction Rail |
| 36 | Terminal Structural Frame |
| 38 | Terminal Support Rail |
| 40 | Terminal Guide Rail |
| 42 | Terminal Vertical Deflection Sheaves |
| 44 | Terminal Tachometer Sheave |
| 46 | Terminal Path Switch |
| 48 | Opening Rail |
| 50 | Support Sheaves |
| 52 | Alignment tires |
| 54 | Power Take-Off Device |
| 56 | LSM Stators |
| 57 | Battery |
| 58 | Alternate Carrier Path |
| 60 | Alternate Carrier Path |
| 62 | Alternate Carrier Path |
| 64 | Detachment point |
| 66 | Attachment point |
| 70 | Alternate Carrier Path |
| 72 | Carrier Facility |
| 90 | Propulsion unit |
| 92 | Master PLC |
| 94 | Monitoring PLC |
| 96 | Sensors |
| 100 | Sensor information |
| 102 | Stator actuation |
| 104 | Stator feedback |
| 106 | System status information |
| 108 | Monitoring PLC status feedback |
| 110 | System shutdown information |

Linear synchronous motors (LSMs) are electromagnetic motors that produce motion without cranks, intermediate gears, screws or other mechanisms. In an LSM, a stator or armature creates a magnetic field that acts upon a reaction rail (e.g., a permanent magnet or electromagnet). Stators are sequentially energized, causing specific polarities of magnetic fields to “travel” along a path defined by the stators. The sequence of stator energization, and thus the speed of travel of the magnetic fields, can be controlled by logic circuits, in particular by a Programmable Logic Controller (PLC). LSMs are the driving force behind high speed maglev trains that can travel at 400 km/hr. LSMs have recently been installed as launch and recovery devices for roller coaster trains. For example, an LSM can be used to launch a fully loaded roller coaster train to 100 km/hr in 2.5 seconds.

The present disclosure relates to a method of conveying carriers within an aerial tramway terminal after the carriers have been detached from a continuously circulating cable, known in the art as a haul rope. Between terminals, each carrier is coupled to the haul rope by a corresponding detachable grip. A reaction rail (e.g., a permanent magnet, or an electromagnet) is mounted to each of the detachable grips. As each carrier enters the terminal, its weight is shifted to a terminal support rail before the grip is mechanically opened and detaches from the moving haul rope. Once detached, motion of the carrier comes under the control of an LSM that interacts magnetically with the reaction rail, independently of the haul rope speed. Stators of the LSMs are installed adjacent to (e.g., above, to the side of or below) the path of the reaction rails mounted to the grips as they pass through the terminal. The LSMs may decelerate the carrier to a slower speed to unload and load passengers and/or cargo, or to move carriers to an alternate terminal support rail; LSMs utilized for such deceleration can be designed to generate electrical power from the interaction that decelerates the carrier. After passengers are unloaded and/or loaded, the LSM may then accelerate the carrier to the haul rope speed before the detachable grip once again couples to the moving haul rope. Alternatively, mechanical conveyances may derive power from the haul rope and may move the carriers for part of the path through the terminal, before or after the carriers are moved utilizing the LSM.

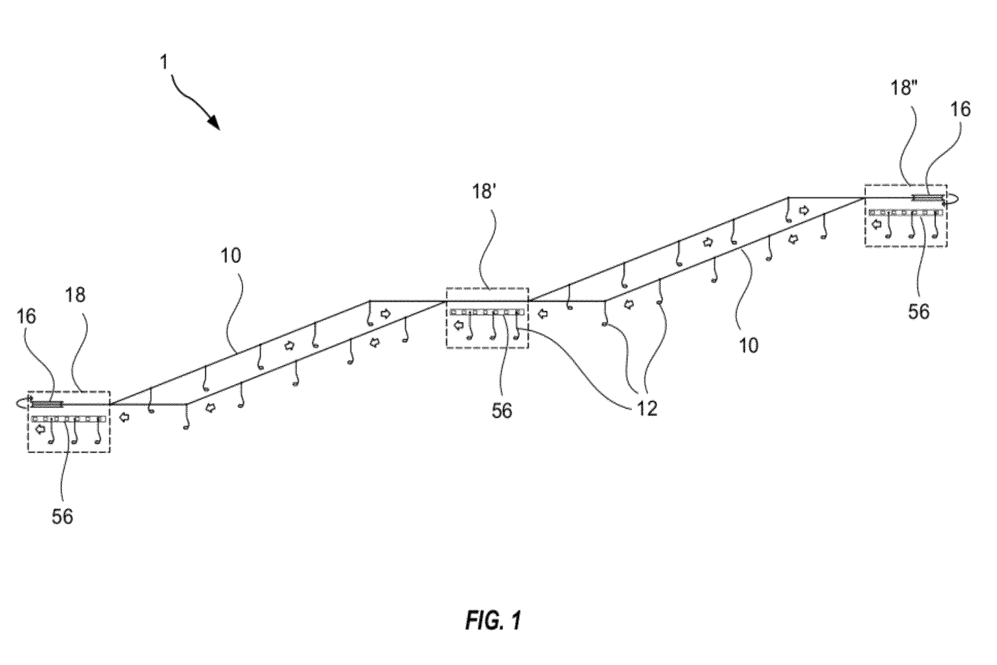

FIG. 1 schematically shows an aerial tramway system 1 that utilizes LSMs to move carriers within terminals thereof. System 1 includes a haul rope 10 to move carriers 12 among terminals 18, 18′ and 18″. At each of terminals 18 and 18″, haul rope 10 loops about a bullwheel 16. Carriers 12 are shown as chairs in FIG. 1, but it is appreciated that carriers 12 may alternatively be gondola cabins, platforms, freight carriers or any other type of carriers capable of detaching from haul rope 10. Within each of terminals 18, 18′ and 18″, carriers 12 may release from haul rope 10 and interact with LSM stators 56 that move carriers 12 within the respective terminals.

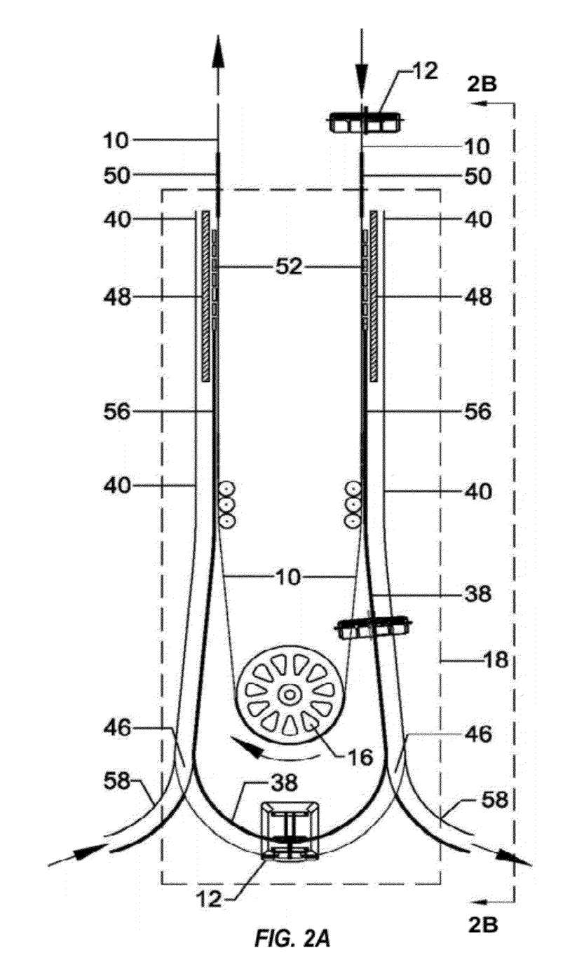

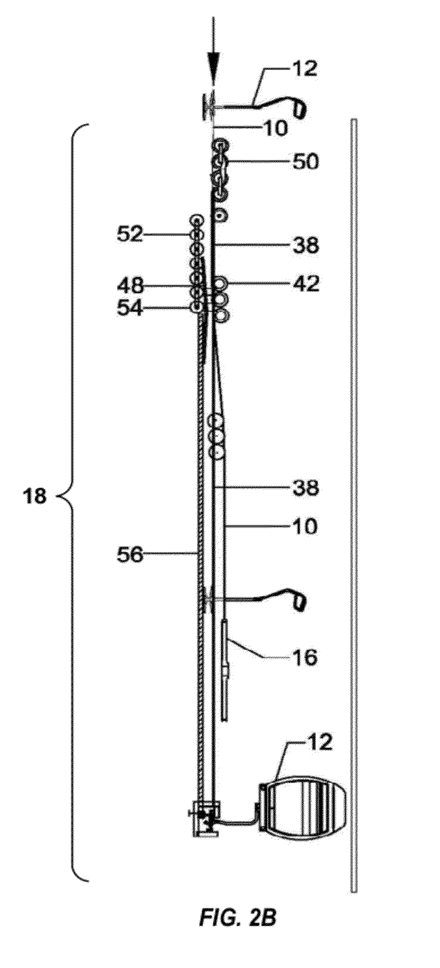

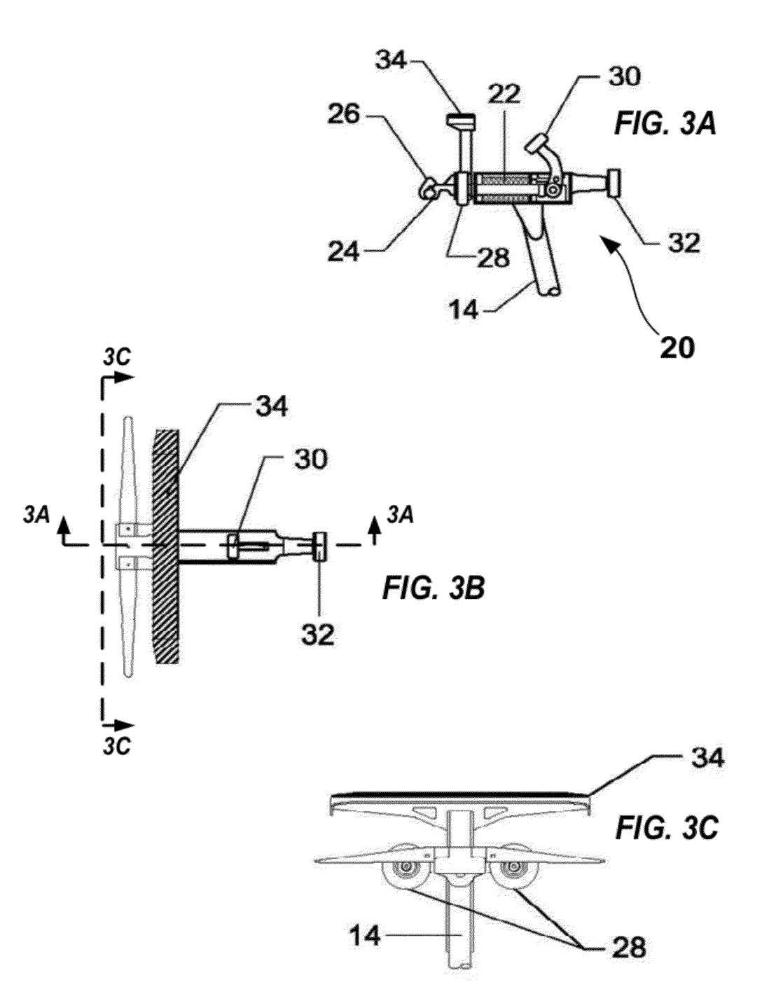

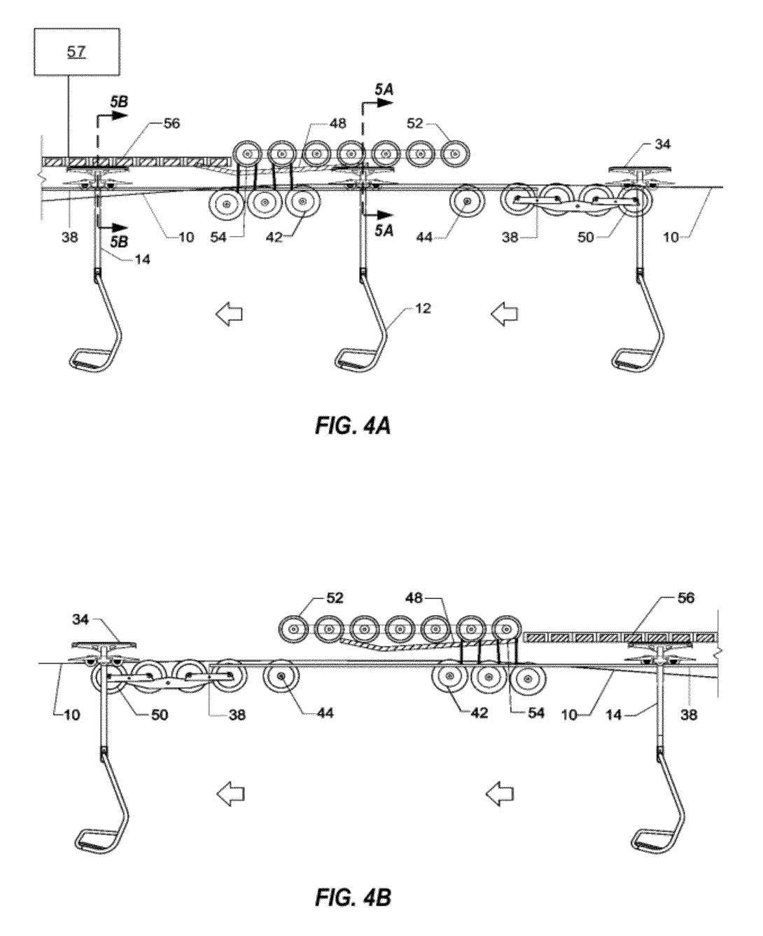

FIG. 2A is a schematic plan view of a portion of an aerial tramway system (e.g., system 1) in which carriers transport passengers and/or cargo. FIG. 2B is a schematic side elevation of the portion of the aerial tramway system of FIG. 2A. Each carrier 12 includes a grip 20 (see FIGS. 3A through 3C), a hanger 14 and a chair, gondola cabin, platform or other fixture for carrying passenger(s) and/or cargo. Between terminals 18 of such systems, carriers 12 are suspended from a haul rope 10 by grips 20. Intermediate towers with sheave assemblies support haul rope 10 and carriers 12 as they move around a loop between terminals 18. As haul rope 10 enters each terminal 18, it may be supported, for example, by a series of vertically mounted support sheaves 50 (see FIG. 4A). Support sheaves 50 align haul rope 10 to ensure that carriers 12 enter terminal 18 at the correct elevation.

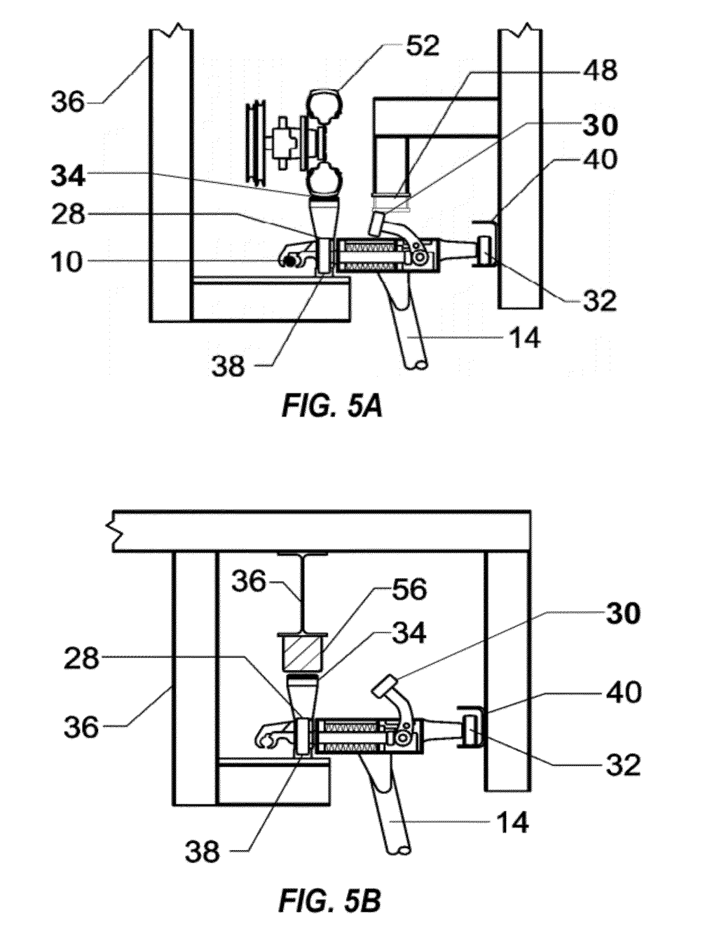

The operation of grips 20 may be understood by reference to FIGS. 3A through 3C, FIGS. 4A and 4B, and FIGS. 5A and 5B. FIGS. 3A through 3C are cross-sectional front elevation, top plan, and side elevation views, respectively, of one grip 20 that releasably attaches a carrier 12 to a haul rope 10. FIG. 4A is a side elevational detail showing carrier entry into terminal 18 (see FIG. 2A), and FIG. 4B is a side elevational detail showing carrier exit from terminal 18. FIGS. 5A and 5B are schematic cross-sectional views of grip 20 interacting with features of terminal 18 as grip 20 passes through terminal 18 at the locations shown in FIG. 4A.

As each carrier 12 enters terminal 18, a terminal support rail 38 and a terminal guide rail 40, each mounted with a terminal structural frame 36, capture a moving grip support roller 28 and a grip guide roller 32. After each carrier 12 contacts terminal support rail 38, its reaction rail 34 contacts an alignment device, for example, a series of rotating alignment tires 52 having a tangential speed of alignment tires 52 that matches the speed of haul rope 10. Alignment tires 52 may be powered by energy transferred from haul rope 10 by a mechanical subsystem such as a power take-off (“PTO”) device 54. When PTO 54 is utilized, the direct connection of alignment tires 52 provides an exact match between speed of haul rope 10 and alignment tires 52. Alignment tires 52 also dampen any side to side swinging motion of carrier 12 as it enters terminal 18. The synchronization and dampening actions both align the motion of carrier 12 with terminal support rail 38. Alternatively, LSMs interacting with reaction rails 34 may be utilized to align carrier 12 with terminal support rail 38. Once carrier 12 is aligned and traveling on rails 38 and 40, a mobile grip jaw 24 of each carrier 12 is mechanically forced open with respect to a fixed grip jaw 26 by an opening rail 48 (see FIG. 4A) that exerts a force on a grip opening roller 30. Once grip 20 is open, a profile of either haul rope 10 or support rail 38 raises the grip above the haul rope. For example, a terminal vertical deflection sheave 42 (see FIG. 4A) may deflect haul rope 10 below a path of grip 20 as the grip continues along the path. Once grip 20 is clear of haul rope 10, a profile of opening rail 48 releases the pressure on grip opening roller 30, and mobile grip jaw 24 closes. (It should be noted that another type of grip, the “over center” grip, remains open from the moment it opens to disengage from a haul rope, until the moment it re-engages the haul rope; either type of grip may be utilized with LSMs.) Meanwhile, reaction rail 34 has neared LSM stators 56 so that reaction rail 34 can be moved by means of magnetic fields generated by stators 56. At this point, grip 20 and thus the associated carrier 12 is under the control of an LSM terminal conveyance system.

In embodiments, reaction rail 34 may include a permanent magnet that interacts with the magnetic fields of stators 56, permanent magnets being a practical alternative for carriers 12 that are chairs or other carriers that do not include an electrical power source. Alternatively, a carrier 12 may utilize one or more electromagnets in reaction rail 34.

The LSM conveyance system controls movement of each carrier 12 in terminal 18 once its grip 20 releases haul rope 10. An LSM includes two primary components: stators 56, and reaction rails 34 that move according to magnetic interactions with the stators. A reaction rail 34 is mounted to grip 20 of each carrier 12. Stators 56 are permanently mounted within terminals along paths of grips 20 through the terminals; stators 56 may be mounted above, to the side or below such paths, as shown further below. Electric currents applied to stators 56 create a magnetic field that is arranged by a control system (e.g., a PLC) to travel along the conveyance. Through this traveling magnetic field, stators 56 interact magnetically with, and thus control the motion of, each reaction rail 34 to provide precise motion and position control of carriers 12. In this fashion, each reaction rail 34 is analogous to the friction plates of prior art grips. The most common design for low acceleration LSM with positioning is a permanent magnet, DC linear brushless motor (LBM) with positive feedback in which an input waveform is precisely synchronized with the speed and position of the moving reaction rail 34. This allows for accurate and flexible control of motion and position of carriers 12 as they travel through each terminal 18. When a carrier 12 nears an end of a terminal 18, the sequence described above is essentially reversed such that motion of the carrier synchronizes to motion of haul rope 10, grip 20 fastens about haul rope 10 and the carrier leaves the terminal, as shown in FIG. 4B.

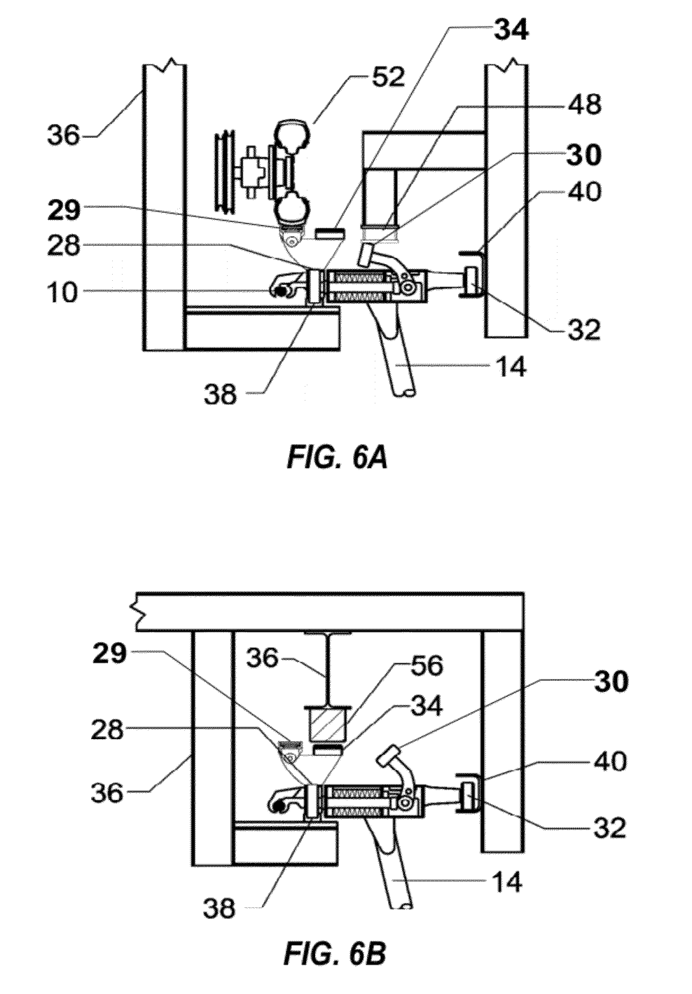

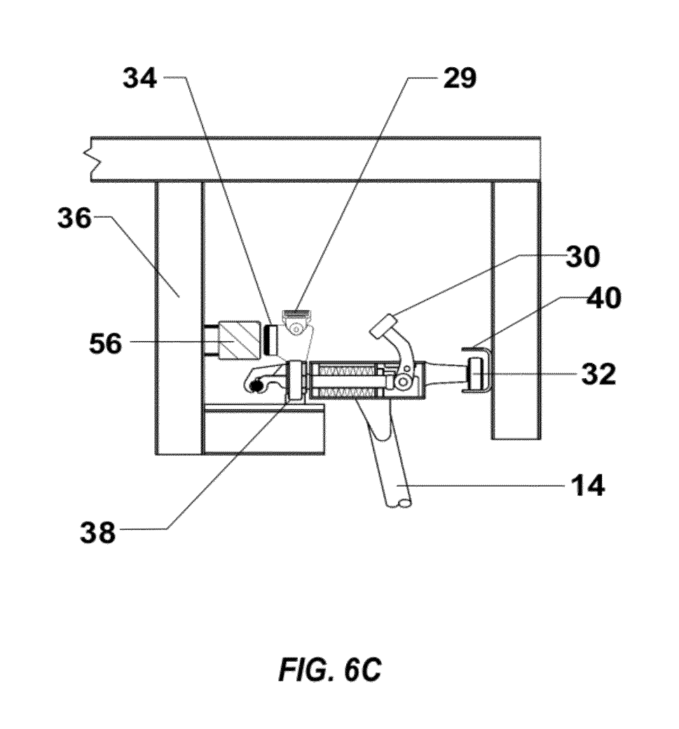

Aerial tramway systems utilizing LSMs can be configured to utilize both reaction rails and friction plates. Such configurations may have slightly higher capital cost (because each grip includes a friction plate in addition to a reaction rail) but may have lower long term costs because the friction plates may take mechanical stresses and wear better than reaction rails. FIGS. 6A, 6B and 6C are front elevation cross-sectional schematic views that show a grip having both a friction plate 29 and a reaction rail 34, within a terminal. FIG. 6A shows friction plate 29 interacting with an alignment tire 52 at one location within the terminal. FIG. 6B shows the same grip as FIG. 6A, with reaction rail 34 interacting with an LSM stator 56 at a different location within the terminal. In FIGS. 6A, 6B and 6C, the path of the grip and carrier is in or out of the plane of the drawing, so in FIG. 6B, LSM stator 56 is above the path of the grip. FIG. 6C shows a different grip, one that has a friction plate 29 mounted so as to interact with alignment tires above the path of the grip through the terminal, but with reaction rail 34 mounted so as to interact with a stator 56 that is to the side of the path of the grip through the terminal, as shown. Reaction rails 34 may also be configured to interact with stators 56 located below the path of a grip through a terminal.

The electromagnetic interaction between stators 56 and reaction rails 34 can also function in reverse as compared to the description above. For example, a reaction rail 34 moving past stators 56 can create a direct current (DC) magnetic flux field that induces electric current within stators 56. Therefore, when carriers 12 decelerate upon entry to a terminal 18, the movement of reaction rail 34 past stationary electromagnetic stators 56 may generate DC electrical power. This is shown in FIG. 4A where LSM stators 56 capture DC electrical power that is stored in a battery 57. The power thus captured may be utilized for any purpose, for example battery 57 may be part of a backup system that can be utilized during a power failure. In the event of a power failure, the charge from battery 57 would power the LSM and all of the stators until the system can be stopped in a safe manner or power can be restored. In another example, the power generated by the carrier deceleration can be used to power a portion of the acceleration stators.

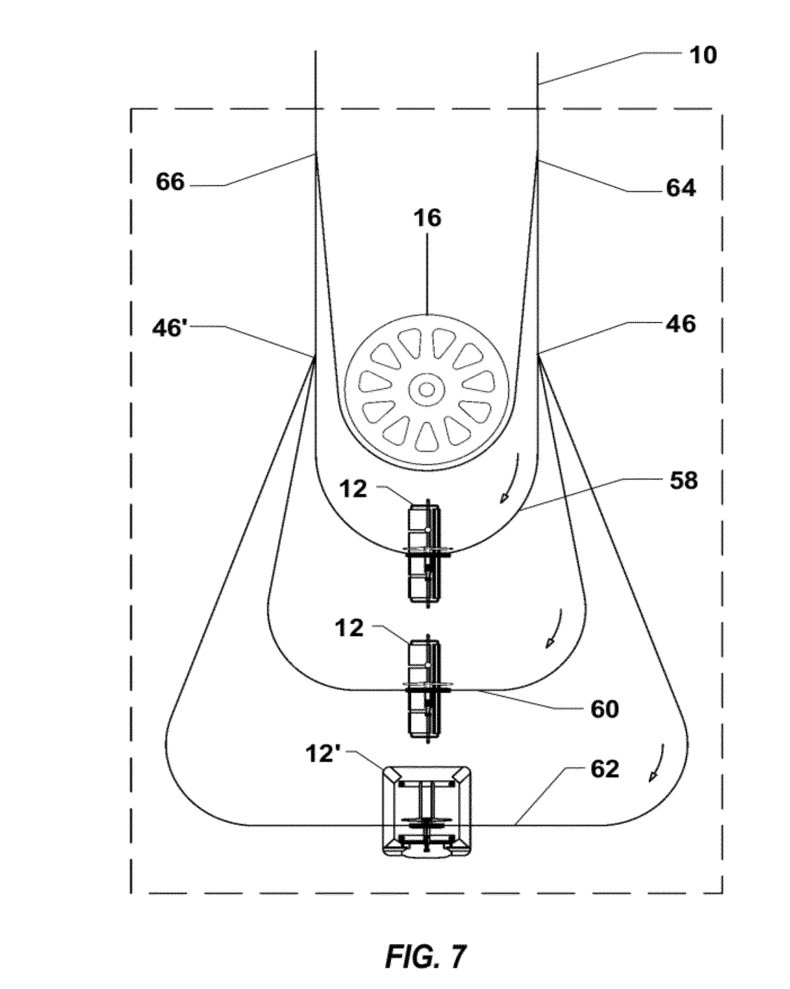

FIG. 7 schematically illustrates alternate carrier paths 58, 60, 62 for an aerial tramway system utilizing LSMs. Carriers detach from haul rope 10 at a detachment point 64 and are thereafter under control of LSMs. An LSM terminal path switch 46 switches each carrier 12 or 12′ to one of alternate carrier paths 58, 60 or 62. LSMs typically move carriers 12 along carrier paths 58, 60, 62, however it is possible for one or more carrier paths to utilize mechanical conveyances. After any desired unloading and/or reloading of carriers 12, 12′ with passengers and/or cargo, LSM switch 46′ rejoins the carriers onto a common carrier path for reattachment to haul rope 10 at an attachment point 66. Because individual carriers 12, 12′ need not move in “lockstep,” and because LSMs are easily configured for switching, operational enhancements such as alternate carrier paths 58, 60, 62 are possible. For example, paths 58, 60, 62 may feed carriers onto a common haul rope 10. Paths 58, 60, 62 may be, for example, loading paths that operate similar to, or differently than, one another. In one embodiment, carriers 12 are chairlift type chairs and there are “express load” and “slow load” loading paths. The “express load” path(s) are for skiers familiar with chairlift operation who wish to get onto the tramway as quickly as possible, and are willing and capable of moving quickly into position to board a moving chair. The “slow load” path(s) can be used by children, handicapped skiers, or even for loading cargo onto a chair or other fixture. In the “slow load” path, a chair may pass through a loading area slowly, or even stop, until its load is safely on board. The tramway may generally move “express load” chairs more quickly through the terminal and onto the haul rope in sequence, but may occasionally interrupt a sequence of “express load” chairs to switch a “slow load” chair onto the haul rope. Alternatively, some carriers 12 may be chairlift type chairs while other carriers 12′ are gondola cabins, with corresponding paths 58 and 60 for carriers 12 and path 62 for carriers 12′ providing appropriate facilities for loading and/or unloading the respective types of carriers. Although three alternate carrier paths are shown in FIG. 7, it is contemplated that any number of alternate carrier paths could be utilized.

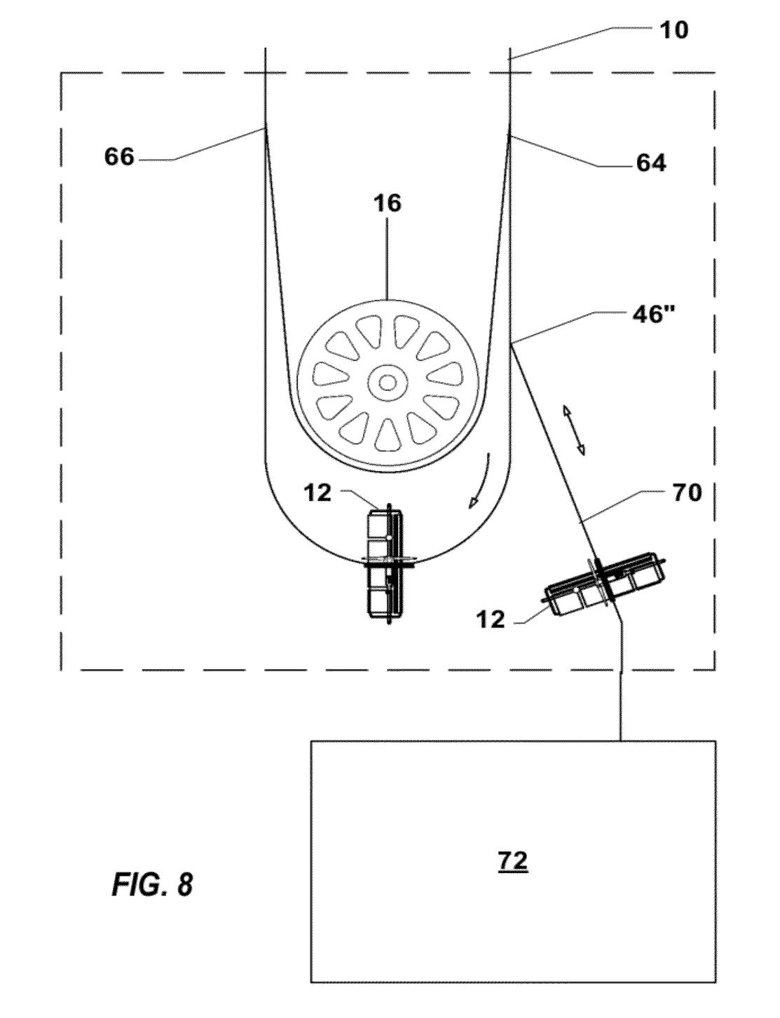

FIG. 8 schematically illustrates an alternate carrier path to a carrier storage facility in an aerial tramway system utilizing LSMs. Carriers 12 detach from haul rope 10 at a detachment point 64 and are thereafter under control of LSMs. As needed, an LSM switch 46″ can divert carriers 12 to, or retrieve carriers 12 from, an alternate carrier path 70 leading to a carrier facility 72 that may be a storage facility, a maintenance shop or both. Carrier path 70 may be a bi-directional rail as shown in FIG. 8, or separate rails may be utilized to divert carriers 12 to the carrier facility and to put the carriers 12 back into the tramway system.

Energy generated by deceleration of carriers as they enter a tramway terminal may be converted by an LSM to electrical energy that may be stored for use as backup power in the event of a temporary power loss, or may be used to power a portion of the LSM stators during positioning or acceleration.

Aerial tramway systems according to embodiments herein are controlled by electronic logic circuitry; for example, a programmable logic controller (PLC) may determine carrier position parameters and direct the LSM to control the motion of the individual carriers. In embodiments, a computer may be used instead of (or in addition to) a PLC. In one embodiment, a master PLC controls all aspects of the entire tramway system while a monitoring PLC confirms that all of the command parameters sent by the master PLC are met. For example, the master PLC may control all operational characteristics of the tramway system, such as speed of haul rope 10 and may dictate movement of carriers 12 within terminal 18 by controlling LSM stators 56. The master PLC thus enforces carrier spacing in real time. A monitoring PLC may passively monitor the entire system to ensure that none of the programmed tolerances are being overlooked by the master PLC. The monitoring PLC may receive information from a variety of speed and/or position input devices (e.g., sensors) as well as operational status from the master PLC, to determine each carrier 12's velocity and/or location. For example, mechanical and/or optical sensors may be utilized to sense carriers 12 in the terminal, and may also sense speed of haul rope 10 or operation of power take-offs associated with attaching or detaching carriers 12 from haul rope 10. Also, since each carrier 12 passing by an LSM stator 56 will induce a voltage in the wiring of stator 56, the monitoring PLC may receive information derived from such voltages. The monitoring PLC may utilize information from all such sources to generate status feedback and provide such feedback to the master PLC. The master PLC determines the spacing at which carriers 12 are placed back onto haul rope 10, adjusts carrier terminal motion as operational commands are given, and can shut down the aerial tramway system upon determining that one or more operational tolerances are violated.

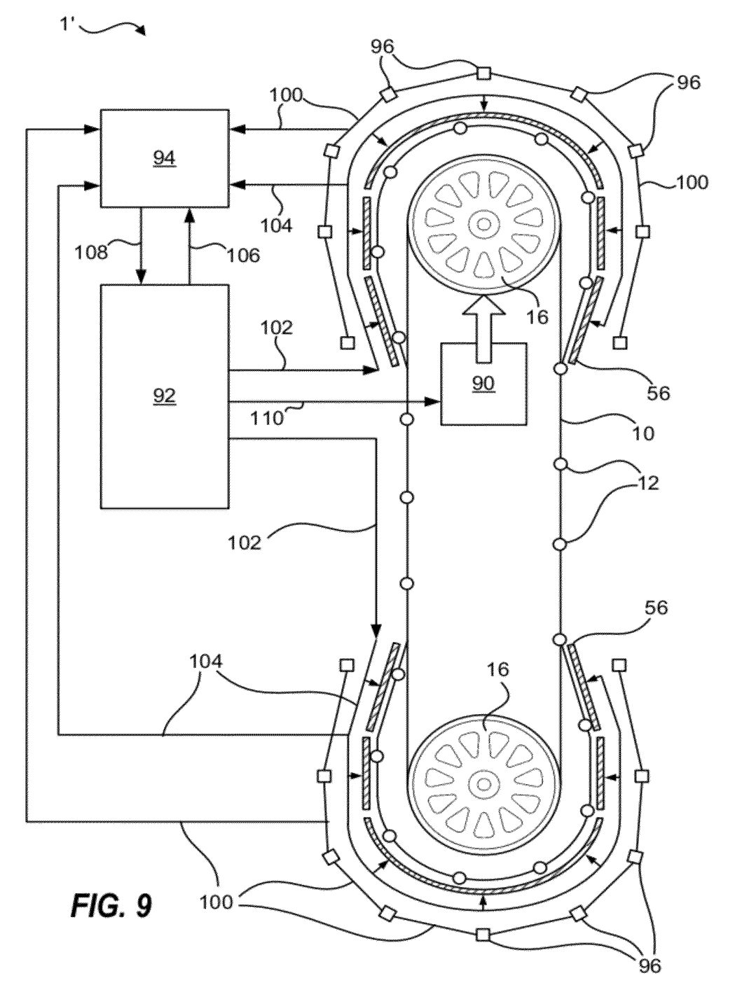

FIG. 9 is a schematic block diagram of an aerial tramway system 1′ illustrating control of the system by a master PLC 92 and a monitoring PLC 94. A propulsion unit 90 drives a bullwheel 16 at one end of system 1′, moving haul rope 10 that loops around another bullwheel 16 at the other end of system 1′. Carriers 12 attach to haul rope 10 between ends of system 1′ but are removed from the system and moved by LSM stators 56 at each of the ends. Sensors 96 sense position and/or location of carriers 12, as well as speed of haul rope 10, operation of power take-offs and other operational aspects of system 1. A terminal tachometer sheave 44, shown in FIGS. 4A and 4B, is an example of a sensor 96; other sensors may be mechanical or optical, or may be radio frequency identification (“RFID”) sensors. Sensors 96 pass sensor information 100 to monitoring PLC 94. Stator feedback (induced voltage) information from LSM stators 56 and system status information from PLC 92 may also be received by PLC 94. PLC 94 generates and provides continuous status feedback 108 to PLC 92. PLC 92 provides sensor actuation 102 to LSM stators 56, and can provide a system shutdown signal 110 to propulsion unit 90 if improper and/or dangerous conditions are detected.

FIG. 9 shows but one exemplary embodiment of a master PLC 92 and a monitoring PLC 94 controlling aerial tramway system 1′. Other embodiments that are contemplated include, for example: a single computer that performs all of the functions of master PLC 92 and monitoring PLC 94; a master PLC 92 for an entire tramway system that interacts with two monitoring PLCs 94, one such monitoring PLC at each terminal of the tramway system; and a master PLC 92 and a monitoring PLC 94 at each terminal of the tramway system.

Also, features of the master PLC 92 and monitoring PLC 94 may be applied to other aspects of aerial tramway system operation. For example, when multiple loading/unloading paths are utilized, a tramway utilizing LSMs may include various means for identifying what carriers 12 have what kinds of payload aboard, so that each carrier 12 is switched into an appropriate unloading path. In embodiments, this information can be generated by PLCs 92 and/or 94 by adding entries to a data structure that records the outgoing sequence of carriers 12 with what alternate carrier path was traversed by each of the carriers during loading. That is, the tramway may create an information buffer with an entry identifying the type of each carrier 12 loaded. This information can be transmitted to an unloading terminal for corresponding switching of the chair into various unloading paths. For example, skiers that chose “express load” may be switched to an “express unload” path, but cargo or skiers that chose “slow load” may be switched to an unload path that slows or even stops the chair or carrier for unloading. In other examples, PLCs 92 and/or 94 may update a look-up type table of payload type, cross referenced to an identifier affixed to the carrier 12 (e.g., a chair number, a barcode, an RFID tag, etc.) that may be sensed by sensors 96. In embodiments, PLCs 92 and/or 94 may utilize such information to route the carrier 12 to an appropriate unloading terminal (e.g., to unload “slow load” passengers at easier terrain, but to give “express load” passengers flexibility to unload at expert terrain).

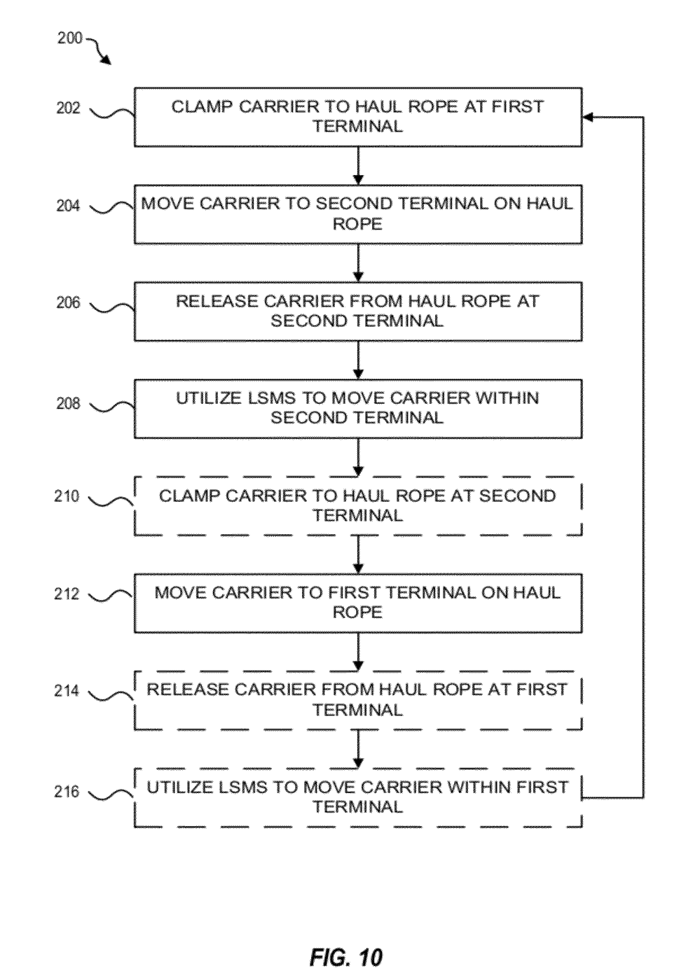

FIG. 10 is a flowchart of a method 200 of moving a carrier on an aerial tramway system utilizing LSMs. Step 202 clamps a carrier to a haul rope at a first terminal of the system. An example of step 202 is clamping a carrier 12 to a haul rope 10 (see FIG. 1). Step 204 moves the carrier to a second terminal of the system on the haul rope. An example of step 204 is moving a carrier 12 from terminal 18 to terminal 18′ or 18″ on haul rope 10 (see FIG. 1). Step 206 releases the carrier from the haul rope at the second terminal. An example of step 206 is releasing a carrier 12 from haul rope 10 at terminal 18′ or 18″ (see FIG. 1). Step 208 utilizes LSMs to move the carrier within the second terminal. An example of step 208 is utilizing LSM stators 56 within one of terminals 18′, 18″ to move a carrier 12 within terminal 18′ or 18″ (see FIG. 1). Steps 210, 212, 214 and 216 repeat the actions of steps 202, 204, 206 and 208 but in the opposite direction or terminal Steps 210, 214 and 216 are optional in the sense that LSMs need not be utilized at both terminals, and the carrier may not be released from the haul rope at one of the terminals (see, e.g., FIG. 1 wherein carriers 12 may stay on the haul rope at midway station 18′ as they transit between terminals 18, 18″).

The ANSI B77.1 standard is the national standard for passenger ropeways. ANSI B77.1 sets requirements on the minimum and maximum acceleration and deceleration rates as well as loading and unloading standards. Additional path length beyond the minimum required by ANSI B77.1 allows for an operational buffer zone when controlled by a PLC and LSMs. Such a buffer zone can increase the system's safety, stability, efficiency and reliability. Coupled with an LSM, the master PLC has the ability and flexibility to move carriers 12 through a terminal 18 under a variety of conditions. Unlike a mechanically linked system, carriers 12 do not have fixed relationships to adjacent carriers. Buffer zones can accommodate operational considerations such as child loading or minor loading/unloading incidents without stopping the entire system. This flexibility can improve the ridership experience and increase the hourly capacity of the system.

During operations, maintenance personnel often perform grip maintenance required by the manufacturer and by ANSI B77.1. As previously noted, to maintain a grip 20, carriers 12 must be removed from the system for disassembly and inspection. The LSM system eliminates many moving tires and pulleys that interfere with automated in line switching, as compared with mechanical conveyance systems. The task of removing and adding carriers becomes much less complex. Carriers 12 can be removed from the system without stopping the lift or requiring manual assistance, and re-spacing carriers 12 can be easily accomplished with the buffer zone.

Preventative maintenance is necessary with any terminal system. The prior art terminal conveyance system may have hundreds of moving parts that are all mechanically linked and must be maintained. These parts may include, for example, tires, pulleys, gears, clutches and V-Belts. All of these parts are in constant motion whenever the tramway is in operation and must be constantly inspected, maintained and periodically replaced. These components create pinch points and are dangerous to work around while the machinery is in motion. The LSM conveyance system eliminates most or all of the conveying tires, gears, pulleys and belts, and replaces them with stationary stators 56. Stators 56 may be designed to avoid physical contact with the reaction rail mounted 34 to the grip assembly at any time as it passes through the terminal. This lack of physical contact helps to preclude wear on the LSM components and may significantly reduce conveyance system maintenance, especially as compared to prior art systems. The LSM conveyance system thus reduces preventative maintenance costs and improves safety.

While in the terminal 18, the LSM and Master PLC control all movement of carriers 12. They are responsible for deceleration, conveyance while loading and unloading, and acceleration. After each carrier 12 is loaded and accelerated to haul rope speed, grip opening roller 30 contacts opening rail 48 and pivots grip opening roller 30. This force retracts mobile jaw 24 of grip 20. Once each grip 20 is open, haul rope 10 is positioned within grip 20 and the opening rail 48 profile releases grip opening roller 30. Stored energy 22 of grip 20 closes the grip and mates it to haul rope 10. At this point, the carrier 12 is no longer under the control of the LSM. Optionally, each carrier 12 may be stabilized as it exits the terminal by another set of alignment tires driven by a power take off device 54.

Advantages of using the LSM carrier conveyance system in an aerial tramway, as compared to prior art mechanically linked carrier conveyance systems, include the advantages described above, and the following advantages.

An LSM carrier conveyance system may be designed and constructed with lower capital cost, depending on its configuration and on economies of scale corresponding to market acceptance.

Maintenance of an LSM carrier conveyance system may be considerably lower. The elimination of moving conveyance parts and wear surfaces greatly reduces long term maintenance costs. Also, by eliminating many moving parts within the carrier conveyance system, many pinch points are removed such that working conditions for operating and maintenance personnel are safer.

An LSM carrier conveyance system may significantly reduce the energy required to convey carriers 12 through the terminal 18, by eliminating long mechanical trains of tires, gears, pulleys and the like that have large friction losses and take considerable energy to run.

Carriers 12 controlled by LSMs can travel along the terminal support rail 38 independent of the speed of haul rope 10. Carriers 12 can be positioned as determined by a PLC (either automatically, or in reaction to input supplied by an operator of the aerial tramway, for example in response to operational issues such as presence of children or novices as chairlift riders, or emergencies or maintenance needs) because the carriers are not in “lockstep” with one another within terminal 18.

Carriers 12 can be added or removed from a terminal carrier conveyance system without stopping the tramway. The LSM carrier conveyance system allows for a much quicker response to carrier re-spacing because carriers 12 do not move in “lockstep” at terminals 18. Instead of being limited to small adjustments, it is possible to make much larger adjustments or even add or remove a significant number of carriers from haul rope 10 by routing the carriers 12 to or from carrier facilities 72.

Magnetic interactions between stators 56 and reaction rails 34 are much less likely to be impaired by incidental snow, ice or other substances on reaction rails 34 than the mechanical interactions between friction plates and tires in prior art carrier conveyance systems.

A terminal rail support system utilizing LSMs can have added length to enable creation of buffer zones to add further operational flexibility. Buffer zones can accommodate even more operational considerations such as child or novice loading and unloading, or minor loading/unloading incidents without stopping the entire tramway system. These zones can increase the system's safety, stability, efficiency, reliability and capacity.

A tramway terminal that utilizes LSMs for carrier movement can have alternate switching paths to simplify adding carriers 12 to, or removing carriers 12 from, a tramway system, or for other purposes. See, for example, terminal path switches 46, 46′ leading to and from alternate carrier paths 58, 60 and/or 62, in FIG. 2A and FIG. 7. LSMs are useful for this purpose because stators 56 can generally be made more compact than systems of tires and pulleys that act on friction plates in prior art systems, so there is less mechanical interference in the vicinity of actual terminal path switches.

In addition to multiple loading/unloading paths, a tramway utilizing LSMs can provide similar flexibility at stations that are not at endpoints of a haul rope, for example “midway” loading/unloading stations as are sometimes implemented on chairlifts (e.g., terminal 18′, FIG. 1). Carriers 12 that loaded through “express load” paths may by default be routed to expert terrain, while carriers 12 that loaded through “slow load’ paths may be routed by default to unload at the midway station where easier terrain is accessible. Carriers 12 that are unloaded at the midway station may be put back onto the upward side of the haul rope to complete the circuit around the tramway, or may be routed to the downward side of the haul rope to reattach when a vacancy along the haul rope is detected.

Aerial tramway terminal conveyance by LSMs may be implemented at any point of an aerial tramway; in particular, for tramways such as ski lift chairs and gondolas that typically operate between two terminal points, such conveyances can be implemented at either or both terminals. It is contemplated that LSMs may be retrofitted to existing terminals of aerial tramways in order to continue use of hardware common to both prior art and LSM based conveyances, including but not limited to the terminal housing, bullwheel 16, terminal guide rails 40 for carriers 12, and so forth. For example, a retrofit kit for a carrier of an aerial tramway system may include a reaction rail configured for attachment with the carrier; the reaction rail includes either a permanent magnet or an electromagnet capable of interacting with LSMs of the tramway system to control movement of the carrier when the carrier is detached from a haul rope of the system. Also, it is possible that LSMs might be utilized only at one or more terminals of an aerial tramway while a prior art conveyance is utilized at one or more other terminals of the same tramway.

While the examples described in this disclosure relate to aerial tramways utilizing LSMs at terminals thereof, it will be appreciated by those skilled in the art that the features described and claimed herein may be applied to similar systems, for example systems that are not “aerial” but travel on wheels, rollers and/or rails, powered by a haul rope. Application of the principles described herein to such other systems may thus be considered to fall within the scope of the disclosed embodiments.

The changes described above, and others, may thus be made in the aerial tramway terminal carrier conveyances by linear synchronous motors described herein without departing from the scope hereof. It should thus be noted that the matter contained in the above description or shown in the accompanying drawings should be interpreted as illustrative and not a limiting sense. The following claims are intended to cover generic and specific features described herein, and should be construed to encompass any statements of the scope of the present method and system, which, as a matter of language, might be said to fall there between.

What is claimed is:

1. An aerial tramway system that conveys carriers between terminals along a haul rope, in which the carriers (a) detach from the haul rope within at least one of the terminals for loading and unloading, and (b) reattach to the haul rope for conveyance to the next terminal, the system comprising:
one or more Linear Synchronous Motors (LSMs), within at least one of the terminals, that move the carriers for at least part of the time that the carriers are detached from the haul rope; and
a plurality of the carriers, each carrier comprising a reaction rail that includes at least one magnet configured for magnetic interaction with the one or more LSMs.

2. The aerial tramway system of claim 1, wherein at least one of the LSMs generates power by interacting with a reaction rail to decelerate the corresponding carrier upon detachment of the carrier from the haul rope, the system further comprising a battery for storing the power thus generated.

3. The aerial tramway system of claim 2, wherein the power stored in the battery is utilized to power the system in the event of interruption of external power to the system.

4. The aerial tramway system of claim 1, further comprising a master Programmable Logic Controller (PLC) that controls the LSMs, thereby controlling movement of the carriers within the at least one of the terminals for at least part of the time that the carriers are detached from the haul rope.

5. The aerial tramway system of claim 4, further comprising:
sensors for sensing position or movement of the carriers, and
a monitoring PLC that utilizes information from the sensors to monitor movement of the carriers within the at least one of the terminals.

6. The aerial tramway system of claim 5, wherein the monitoring PLC generates evaluations of operational conditions, and communicates the evaluations to the master PLC.

7. The aerial tramway system of claim 6, wherein at least one of the master PLC and the monitoring PLC is configured to shut down the tramway system when the evaluation of operational conditions indicates an operational tolerance violation.

8. The aerial tramway system of claim 1, wherein the at least one magnet comprises one of a permanent magnet and an electromagnet.

9. The aerial tramway system of claim 1, wherein the system utilizes the reaction rail to align the carriers with a terminal support rail.

10. The aerial tramway system of claim 1, wherein stators of the LSMs are positioned within the at least one of the terminals along a path along which the reaction rails of each of the carriers move, such that the stators interact magnetically with the reaction rails.

11. The aerial tramway system of claim 10, wherein the stators are positioned at least one of above the path, to the side of the path, and below the path.

12. The aerial tramway system of claim 1, further comprising:
terminal path switches capable of switching carriers among a plurality of carrier paths within the at least one of the terminals, movement of the carriers along at least one of the plurality of carrier paths being caused by the one or more LSMs.

13. The aerial tramway system of claim 12, further comprising:
a master Programmable Logic Controller (PLC) that controls the LSMs, thereby controlling movement of the carriers within the at least one of the terminals for at least part of the time that the carriers are detached from the haul rope;
the master PLC being configured to store information of a carrier path traversed by one of the carriers at a first one of the terminals, and to route the one of the carriers to a corresponding carrier path at a second one of the terminals.

14. The aerial tramway system of claim 1, further comprising a mechanical subsystem, powered by the haul rope, that synchronizes speed of each carrier with the haul rope as the carrier detaches from or attaches to the haul rope.

15. The aerial tramway system of claim 1, wherein one or more of the LSMs synchronize speed of each carrier with the haul rope as the carrier detaches from or attaches to the haul rope.

16. In an aerial tramway system that conveys carriers between terminals along a haul rope, in which the carriers (a) detach from the haul rope at one or more detachment points within at least one of the terminals for loading and unloading, and (b) reattach to the haul rope at one or more reattachment points for conveyance to the next terminal, an improvement comprising:
one or more Linear Synchronous Motors (LSMs) within at least one of the terminals, that move the carriers for at least part of the time that the carriers are detached from the haul rope; and
a plurality of reaction rails, each of the reaction rails associated with one of the carriers and configured for electromagnetic interaction with the one or more LSMs, to move the carriers.

17. A carrier for an aerial tramway system, comprising:
one of a chair, a freight carrier, and a gondola, and
a reaction rail configured for magnetic interaction with a linear synchronous motor of the tramway system, to control movement of the carrier.

18. The carrier of claim 17, the reaction rail comprising one of a permanent magnet and an electromagnet.

19. A retrofit kit for a carrier of an aerial tramway system, the retrofit kit comprising:
a reaction rail configured for attachment with the carrier, the reaction rail comprising one of a permanent magnet and an electromagnet for magnetic interaction with a linear synchronous motor of the tramway system, to control movement of the carrier for at least part of the time that the carrier is detached from a haul rope of the tramway system.

20. A method of moving a carrier of an aerial tramway system, comprising:
clamping the carrier to a haul rope to move the carrier between terminals of the aerial tramway system;
releasing the carrier from the haul rope at one of the terminals; and
utilizing one or more Linear Synchronous Motors (LSMs) to move the carrier within the one of the terminals.

21. The method of claim 20, further comprising:
generating power in at least one of the LSMs by utilizing the at least one of the LSMs to interact with a reaction rail of the carrier to decelerate the carrier upon detachment of the carrier from the haul rope; and
storing the power thus generated in a battery.

22. The method of claim 21, further comprising utilizing the power in the battery to operate at least one of the LSMs when external power to the aerial tramway system fails.

23. The method of claim 20, further comprising controlling one or more of the LSMs through a master Programmable Logic Controller (PLC), thereby controlling movement of the carrier for at least part of the time that the carrier is detached from the haul rope.

24. The method of claim 23, further comprising:
transmitting at least one of position or movement information of the carrier from at least one sensor to a monitoring PLC;
generating evaluations of operational conditions with the monitoring PLC; and
communicating the evaluations to the master PLC.

25. The method of claim 20, further comprising switching the carrier among a plurality of carrier paths within the one of the terminals.

26. The method of claim 25, further comprising
controlling at least one of the LSMs through a master Programmable Logic Controller (PLC), thereby controlling movement of the carrier for at least part of the time that the carrier is detached from the haul rope;
storing information of a carrier path traversed by the carrier at a first one of the terminals; and
utilizing the information to route the carrier to a corresponding carrier path at a second one of the terminals.

27. The method of claim 20, further comprising utilizing a mechanical subsystem that is powered by the haul rope for at least one of detaching the carrier from the haul rope and attaching the carrier to the haul rope.
